(19) United States
(12) Patent Application Publication
(10) Pub. No.: US 2004/0117155 A1
(43) Pub. Date: Jun. 17, 2004

(54) Work Order System

(75) Inventors: George H. Lane III, Atlanta, GA (US); Joseph L. Cox III, Riverdale, GA (US); Rajeev Patel, Suwanee, GA (US)

Correspondence Address: MORRIS, MANNING & MARTIN LLP, 6000 FAIRVIEW ROAD, SUITE 1125, CHARLOTTE, NC, 28210, US

(73) Assignee: TEK-LINK SOFTWARE SYSTEMS, LLC, Atlanta, GA (US)

(21) Appl. No.: 10/605,071

(22) Filed: Sep. 5, 2003

Related U.S. Application Data
(62) Division of application No. 10/041,936, filed on Jan. 7, 2002.

(51) Int. Cl. G06F 15/00; G06F 11/30

(52) U.S. Cl. 702/184

(57) ABSTRACT

A method for processing maintenance work orders includes: identifying a maintenance problem; generating a work order for the maintenance problem in a computer, including at least the location of the problem and the type of the problem; assigning the work order to a technician; entering data from the technician in the computer relating to the technician completing the work order, including at least the action taken to fix the problem and the elapsed time to complete the work order; and comparing the elapsed time entered by the technician for the completed work order to a predetermined standard benchmark for the type of maintenance problem to measure the efficiency of the technician in fixing the problem.

### CROSS REFERENCE TO RELATED APPLICATIONS

The present application is a divisional application and claims under 35 U.S.C. §§ 120 and 121 the benefit of the effective filing date of U.S. patent application Ser. No. 10/041,936, filed Jan. 7, 2002, which application is hereby incorporated by reference.

### BACKGROUND OF INVENTION

The present invention generally relates to a work order system for accomplishing maintenance utilizing service technicians, such as in an individual hotel, apartment, office building, hospital or group thereof or other similar type of maintenance operation. The work orders are entered into a database and the service operations of the technician in responding to each work order are entered and analyzed to enhance the maintenance operation.

The most challenging technical task at the very heart of any maintenance operation is the most efficient utilization of resources, including the available service technicians. This can be a very complex operation, for example, a typical apartment management system having on the order of 30,000 apartment units can have over 200,000 service work orders in a year. Typically, the supervising technician or supervisor, who knows and remembers the skills of the service technicians who are working for the management maintenance system, has handled and assigned these work orders. The supervising technician will receive the work orders individually or in groups from the management office as the work requests are received and the work orders are generated. Depending upon which technician is available and what the supervising technician remembers or knows of their skills, the supervising technician then assigns the work orders to the individual technicians. The technician then proceeds to the site of the work order and provides the required maintenance.

The technician then reports back to the supervising technician or the management office as the work orders are completed or on a periodic basis as the technician needs further work or the technician's shift is finished. In a typical system, the work orders are in a paper based format and may be discarded, placed into boxes or files or summarized or otherwise entered into a computer system to maintain some type of maintenance record. The maintenance data is not utilized in a manner that is as efficient as desired and when maintained on paper, is not particularly useful in analyzing the maintenance operation or the actions and skills of the technicians working in the system over a period of time or if the supervisor leaves or is transferred to another location.

One current type of work order control system includes a pegboard, multi-copy paper process to initiate, assign and record completed work orders. It is estimated that this paper process occupies in excess of twenty percent of the individual maintenance technician's time. At best this system is cumbersome as a source of information to be utilized for analyzing the work orders and the technicians handling the work orders. At worst this system is basically worthless as a source of information, which can be utilized for analyzing the work orders and the technicians handling the work orders in any reasonable manner. The paper process is inefficient and time consuming for the office staff, supervisors and the technicians themselves. Work orders typically are written by the office staff, which involves legibility, interpretation and non-productive time in the maintenance process. Supervisors and technicians are required to make repeated trips to the office to collect, evaluate, interpret, assign and personally distribute and return these paper medium work orders.

With the advent of wireless personal digital assistants (PDA's), it would add further efficiency to have the work orders generated in a digital form, such that the work orders can be transmitted and the maintenance operations can be reported wirelessly. Some systems have been developed to perform these functions by a local area network (LAN) or by wireless communications; however, these systems generally have been developed solely to replace the paper-based operations and do not add the data analyzing capabilities that would be desired to more fully utilize the data currently generated or data, which could be generated.

It thus would be desirable to provide a computer based, preferably wireless, data entry and data analyzing system to more efficiently provide and maintain a work order maintenance system.

### SUMMARY OF INVENTION

The present invention utilizes a data based work order system to maintain the maintenance records, including the work orders, the technicians assigned, the data from the maintenance performed, including the time required to perform the maintenance and any other desired information related to the work order. The system can analyze the data entered to perform various desired functions, such as comparing the time taken to perform a specific type of work order with a standard benchmark time for a comparable work order maintained by the system, which can be an average of all similar types of work orders or just a desirable benchmark time. The system can interactively, preferably by use of wireless PDA's, interact with the service technician as the work order progresses. The service technician can enter the typical operations into the PDA and hence into the data base, such as the start time, pauses, parts replaced or ordered, completion or noncompletion and the reasons therefore, etc. The work order generally will include specific data when it is entered, such as time received, priority, location, type of maintenance required, for example, broken door, inoperable oven, leaking refrigerator or other type of plumbing, etc.

The system can provide the technician with an electronic decision hierarchy from an inventoried set of pre-identified work order problems, which the technician can utilize to select solutions to the problems identified by the technician as the maintenance is completed. The data also can be analyzed to update, develop or compare benchmarks for a specific type of work order. The data can include warranty information and scheduled maintenance for appliances, such as water heaters, ovens, air conditioning and heating units. The data can be analyzed to provide information specific to the skills of each specific technician and to indicate where training is warranted for specific types of work orders, such as from a comparison with the relevant work order benchmark. The data can be analyzed to spot trends and problems associated with specific types of equipment or specific sites or apartment units. Further, the database can be utilized to generate reports automatically or on demand, including routine and customized reports.

### BRIEF DESCRIPTION OF DRAWINGS

Benefits and further features of the present invention will be apparent from a detailed description of preferred embodiments thereof taken in conjunction with the following drawings, wherein like elements are referred to with like reference numbers, and wherein:

FIG. 1 illustrates a block diagram of a general work order embodiment of the present invention.

FIG. 2 illustrates a flow chart of one illustrative work order operation of the present invention.

FIG. 3 illustrates a flow chart of one illustrative work order operation with the decision hierarchy of the present invention.

FIG. 4 illustrates a flow chart of another illustrative work order operation of the present invention.

### DETAILED DESCRIPTION

As a preliminary matter, those persons skilled in the art readily will understand that, in view of the following detailed description of the preferred devices and methods of the present invention, the present invention is susceptible of broad utility and application. Many methods, embodiments, and adaptations of the present invention other than those herein described, as well as many variations, modifications, and equivalent arrangements, will be apparent from or reasonably suggested by the present invention and the following detailed description thereof, without departing from the substance or scope of the present invention. Accordingly, while the present invention is described herein in detail in relation to preferred methods and devices, it is to be understood that this detailed description only is illustrative and exemplary of the present invention and is made merely for purposes of providing a full and enabling disclosure of the invention. The detailed description set forth herein is not intended nor is to be construed to limit the present invention or otherwise to exclude any such other embodiments, adaptations, variations, modifications and equivalent arrangements of the present invention, which is limited solely by the claims appended hereto and the equivalents thereof.

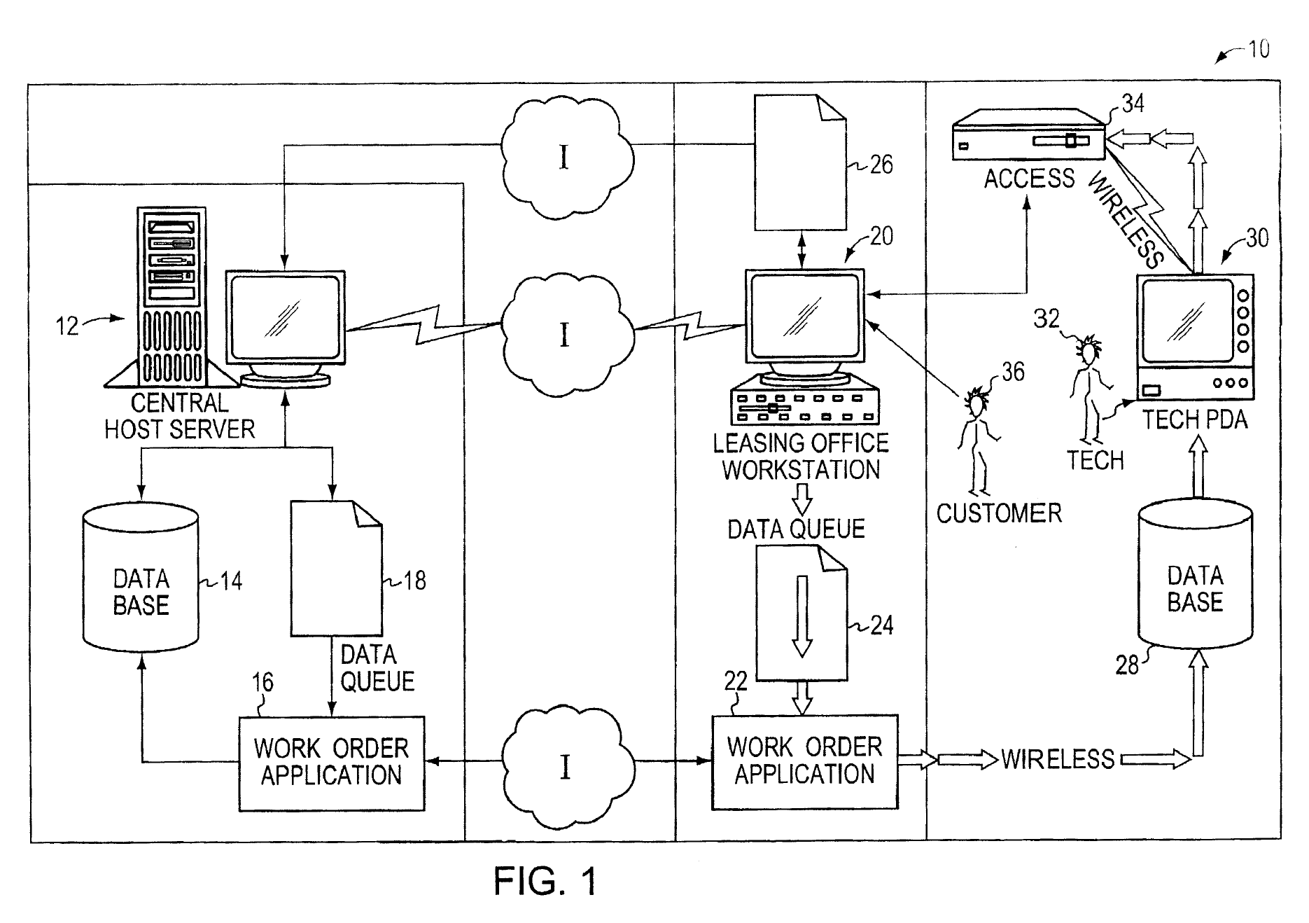

Referring now to FIG. 1 a general work order system embodiment of the present invention is indicated generally by the reference numeral 10. The system 10 can include a variety of configurations and specific elements to achieve the functions of the present invention. The specific embodiment illustrated in FIG. 1 is one example, which will be utilized to describe the general functions of the present invention. The system 10 includes a central host server 12, which includes a database 14, which in turn receives communications and information from a work order application 16 (indicated by a block) and sends a queue of work orders and other information 18 to the work order application 16, in a conventional manner. The system 10 preferably includes at least some Internet (I) and/or wireless links, but could also operate with the utilization of a LAN.

The server 12 is coupled by a LAN or the Internet, as illustrated, to a management or leasing office, which includes a workstation or computer 20 and to a mating work order application 22 (indicated by a block). The workstation 20 provides the work orders to the server 12 and the work order applications can also be provided in conjunction with the server 12 or can be directly provided by the workstation through a queue 24 to the application 22, as illustrated. The workstation 20 can, for example, provide emergency work orders directly through the application 22. The workstation 20 also can include a paper or other type of backup queue 26, which is also coupled to the server 12, again in a known manner. The work order applications 16 or 22 are sent to a data storage device 28 in or coupled to a PDA 30, which is operated by a technician 32. The work order applications 16 and 22 are illustrated as separate applications, but could be a single application, accessed by both the server 12 and the workstation 20. Also, the server 12 and the workstation 20 are illustrated as separate units, but could also be combined as a single unit in the office with the workstation 20. The technician 32 can communicate with the workstation 20, such as through an access point 34, and to the server 12 through the workstation 20 or directly via the Internet (not illustrated). A customer or resident 36 also can communicate a maintenance problem with the office personnel via a phone or fax or directly via email or via the access point 34 (or equivalent operation) with the workstation 20. Typically, the communications are provided with security and the technician 32 and/or the resident 36 will first enter a security code, such as a password, to establish a communication link with the workstation 20.

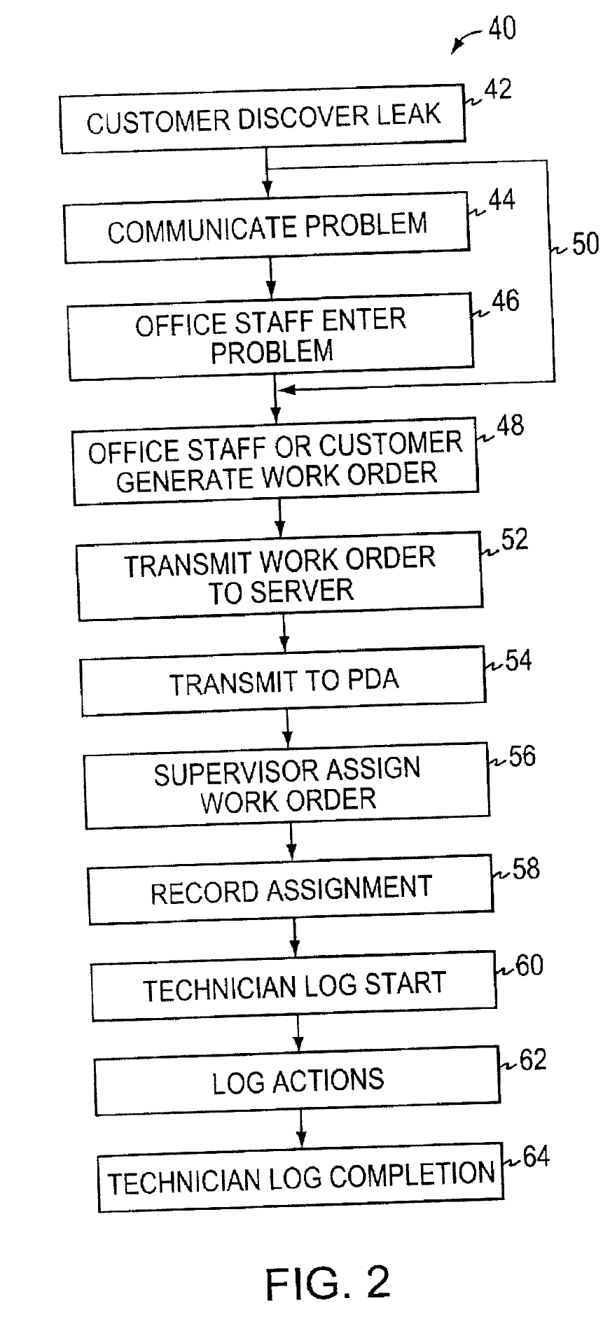

Referring now to FIG. 2, a flowchart 40 of the operation of one example work order request in the system 10 is illustrated. Depicted is the discovery 42 of a water leak in the kitchen by the resident or customer 36. The resident 36 then communicates in step 44, the problem to the office/workstation 20, such as by calling/faxing or emailing a receptionist in the office (not illustrated). The office receptionist or other personnel then enters the problem into the workstation 20 in a step 46 and generates a work order in a step 48, which preferably is very descriptive. Alternately, the resident 36 electronically enters the problem directly into the workstation 20, skipping the steps 44 and 46 as illustrated by a line 50 to generate the work order, such as with an interactive screen, to obtain the necessary work order information. The work order is then transmitted to the server 12 in a step 52 and then to the work order application 16. The work order is then transmitted to the PDA 30 in a step 54. The PDA 30 can be the PDA of the technician 32 who will do the maintenance or it can be the PDA of the supervising technician (not illustrated) who then will assign the work order to the best available technician in a step 56. To assign the work order directly to the best available technician without the input of the supervising technician, the system 10 preferably includes the information in the database 14 to allow the technician 32 to be selected automatically from the available roster or by the office personnel. Since the technicians and their skills and aptitudes for the various types of work orders are maintained in the database 14, they easily can be matched with the entered work order for assignment.

If the supervisor is assigning the work order, then the supervisor can directly communicate with the selected technician 32 or the supervisor can communicate with the office or the server 12 and the work order is then sent to the assigned technician's PDA 30. The supervisor can, of course, assign the work order to himself, depending upon the staffing, skill and workload requirements. If the supervisor has communicated directly with the technician, then either the technician or the supervisor will communicate the assignment to the server 12 for recording in a step 58. The server 12 maintains the listing of all the work orders in process in the system 10, as well as the technicians working on each of the work orders. The technicians themselves also may be multitasking, since they may be waiting for a part on one work order or allowing adhesive to dry or something to cool off, etc., as the case may be. While one work order is on hold the technician 32 enters a pause and logs onto another work order, thus increasing productivity for the technician and hence the system 10. The system 10 allows the technician to have multiple work orders in process simultaneously. This encourages the technician 32 to creatively proceed with the assigned work orders and increases productivity. The system 10, thus allows the office or other management members to track employee productivity and efficiency for a more optimum allocation and management of resources, which can be utilized by any industry which has a need to monitor and manage maintenance technicians locally or over a wide area in one or more facilities.

Once the technician 32 begins a work order, the technician logs the start time of the job onto the server 12 via the PDA 30 in a step 60. As the technician 32 works on the work order, the technician logs the actions taken, again utilizing the PDA 30 in a step 62. Although only a single step is illustrated, the step 62 will be a continuous or substantially continuous series of entries by the technician 32 as the job proceeds. The technician preferably enters the entries simultaneously or substantially simultaneously as the technician 32 performs the work order. The entries also can be entered by the technician 32 on the PDA 30 or similar device in a local mode and then transmitted or down loaded in a batch mode at the end of the shift or whenever convenient with the work flow of the technician 32. These entries are entered into the database 14 to provide the data to analyze and compare with benchmarks or other work orders and other technicians. This data can be, for example purposes, pauses, parts replaced and/or ordered, completion or no completion or other relevant information, such as additional or collateral work orders that arose out of the initial work order. Collateral work orders can be for example, the leak caused a pipe to rust or wood damage under the pipe, which needs replacing. Entering of these collateral work orders allows the system 10, but more likely the supervising technician, to assign the technician 32 to do the work order at the time, if that is the most efficient use of the technician's time. Even if it is not efficient, the collateral work order may be an emergency, which requires immediate attention and hence will be immediately assigned for that reason.

Once the technician 32 has completed the work order, the technician 32 logs the completion into the system 10 in a step 64. The completion is then forwarded to the workstation 20 and to the customer or resident 36. The data entered by the technician 32 is stored in the database 14 and then is utilized to measure the productivity and efficiency of the technician 32. The total elapsed active time (pauses being deleted from the total time) taken by the technician 32 to complete the work order is compared with the predetermined benchmark for the problem and can also be utilized to update the benchmark by averaging the elapsed time into the stored benchmark times. The system 10 allows the office and the supervisor to actively monitor the progress of all the work orders issued, which in turn provides greater efficiency in the maintenance operation. This also allows the office and/or the supervisor to respond to inquiries about the status of the work order to the resident 36. The measuring of productivity and efficiency of the technician 32, further allows for optimum allocation and management of available resources. Another feature provided by the accumulated data is the monitoring of specific installed equipment, specific units to monitor the durability of specific types of equipment, such as a certain type of refrigerator fails consistently after the warranty period, then that information can be utilized in purchasing decisions. Problems logged with a specific unit can be utilized to spot trends, such as misuse of the unit. The time taken by the technician 32 to complete the work order, which greatly or consistently exceeds the benchmark for the particular type of work order, can indicate a lack of training on the particular type of problem for the technician 32. The technician 32 then can be scheduled for the indicated training.

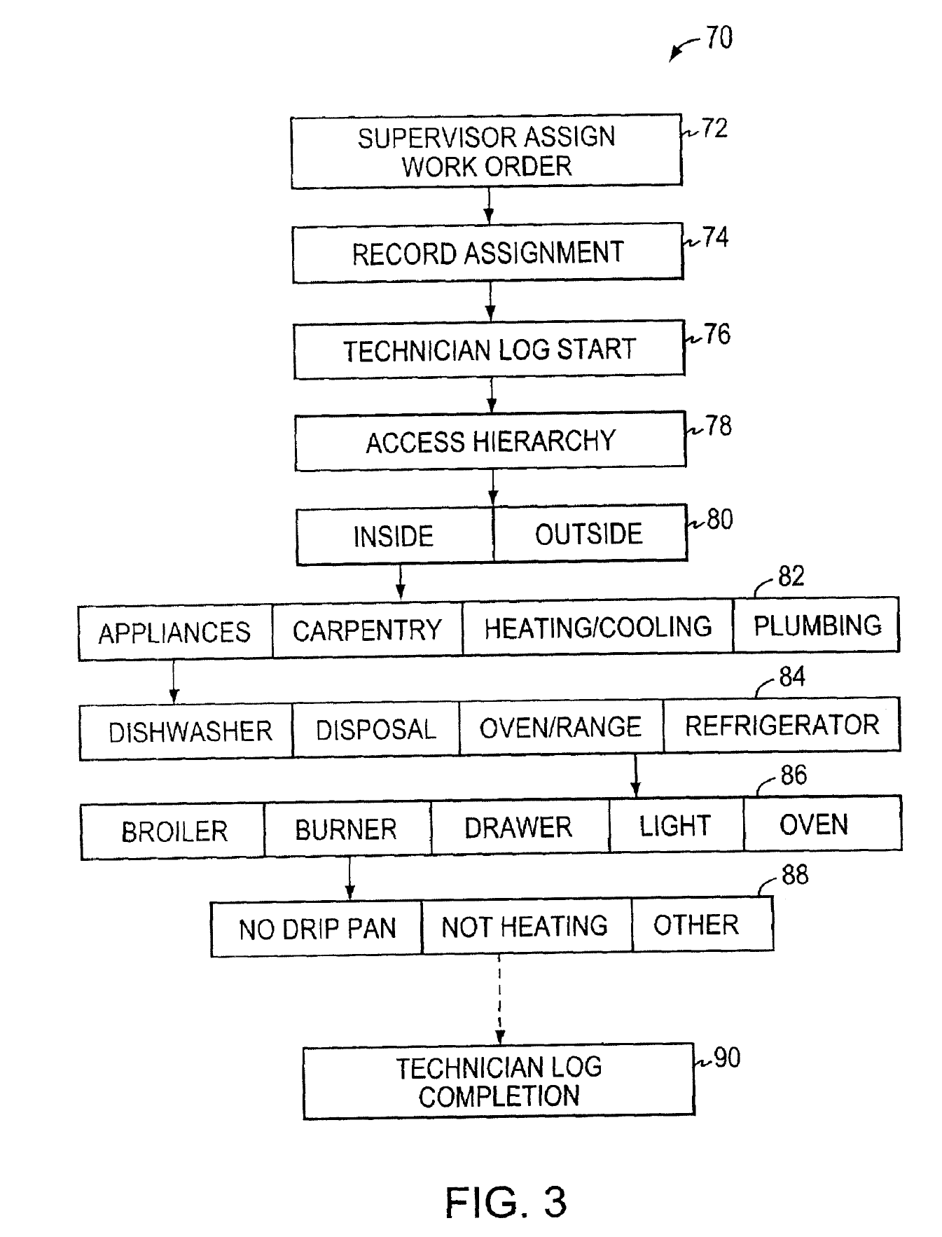

Another benefit of the system 10 is the ability to provide a preferably interactive decision option hierarchy to the technician 32 as the technician 32 proceeds with the work order. The utilization of the hierarchy provides a guide to the technician 32 in proceeding with the work order. This is especially useful when the technician 32 has not been assigned such a work order before or often enough to be familiar with the steps required to complete the work order. The decision option hierarchy is especially useful to the technician 32, when the technician 32 has access to a LAN or a wireless network with the PDA 30. With the PDA, the technician 32 can interactively obtain the options without any substantial delay and without waiting to speak to the supervisor or another technician skilled in the particular problem. The operation of a work order with an example hierarchy is illustrated by a flow chart 70 in FIG. 3.

The technician 32 again has a work order assigned in a step 72. The previous steps illustrated in FIG. 2 are omitted as being identical or substantially identical to those already described. The assignment is again recorded in the database 14 in a step 74 and the technician 32 again logs the start of the work order in a step 76. In this example, the work order is directed to an appliance; specifically the back burner on the customer's stovetop will not heat up. Although the hierarchy is not limited to any specific organization, an alphabetically sorted list is generally the most logical and easily navigated list, especially with the PDA 30. For example purposes the list will be navigated without skipping entries, however, the technician 32 who has familiarity with the system list can and generally will skip entries to save time.

The technician 32 will access the hierarchy list in a step 78. A first option screen in a step 80 can list two options: Inside-Outside. The technician 32 selects “Inside”, which results in a second option screen in a step 82. The screen lists four options: Appliances-Carpentry-Heating/Cooling-Plumbing. The technician 32 selects “Appliances”, which results in a third option screen in a step 84. The screen lists four options: Dishwasher-Disposal-Oven/Range-Refr-igerator. The technician 32 selects “Oven/Range”, which results in a fourth option screen in a step 86. The screen lists five options: Broiler-Burner-Drawer-Light-Oven. The technician 32 selects “Burner”, which results in a fifth option screen 88. The screen lists three options: No drip pan-Not heating-Other. The technician 32 selects “Not heating”, which results in another option screen (not illustrated), etc. until the final solution is reached and the technician 32 logs that the work order is completed in a step 90. Each screen preferably is limited to a limited number of elements for ease of use on the limited screens of the PDA's 30, but is not so limited.

In a typical operation, the work order is entered with the known critical information entered relative to the unit in question, preferably by the program automatically pulling the pre-entered information from the database 14. The specific characteristics of the location or unit can include the resident's name, telephone number, pets, disabilities, access restrictions, types of appliances, etc. This can result in screens tailored to the specific unit and the specific Oven/Range, including the model, warranties and previous maintenance work orders on the appliance. This further speeds up the maintenance and resolution of the work order by the technician 32.

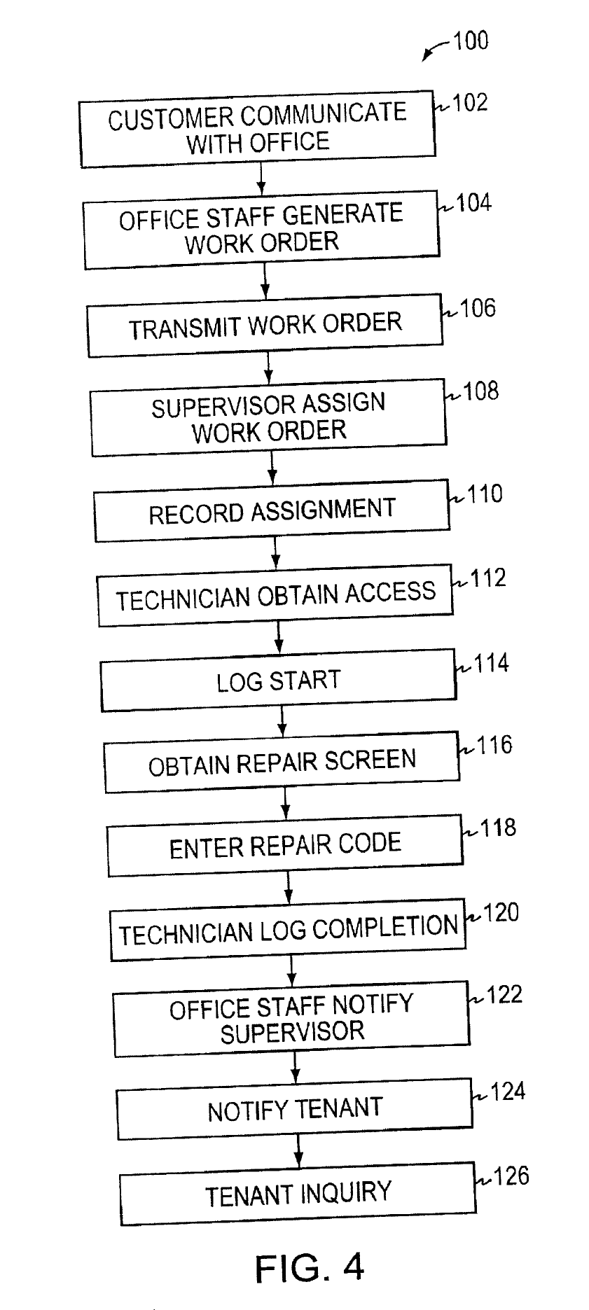

Another example of a work order scenario is illustrated by a flow chart 100 in FIG. 4. A customer or resident, Mrs. Bell, calls the management office to report that her dishwasher is not working in a step 102. Nancy, who is a relatively new agent, answers the phone and asks Mrs. Bell for more information. Mrs. Bell replies that she doesn't know, that's what maintenance is supposed to know, but she needs it fixed before she returns home. Nancy replies that she will promptly generate a work order to have the dishwasher immediately fixed. Nancy enters the data and generates the work order on the workstation 20 in a step 104 by following a simple series of drop down screens, starting with the unit identification number, then selects appliances and dishwasher and not running, which can be a code such as DW3, to minimize the information to be transmitted and displayed by the PDA. Once completed, the work order is then transmitted to the supervisor's PDA in a step 106. The supervisor reviews the work order and his available staff technicians and assigns the work order to Marvin, who has time and has or most closely possesses the requisite skills, in a step 108.

Marvin reviews the work order on his PDA 30, which displays DW3 or Dishwasher not working, Mrs. Bell's unit number, her name, her contact phone number, and a no pet status. Marvin completes and logs out of the work order he currently is working on. Marvin then either proceeds directly to the unit if someone is available with the authority to access the unit or proceeds to the office to obtain the key to Mrs. Bell's unit, since master keys generally are not available to the technicians or are prohibited entirely. Marvin either has already been recorded as having the assignment in a step 110 or he records the assignment to sign out the key in a step 112. Marvin then proceeds to Mrs. Bell's unit, enters and walks into the kitchen and logs the start time of the work order in a step 114. Marvin opens the dishwasher and sees the problem, which is a cap lodged under the dishwasher float. Marvin removes the cap, closes the door and starts the dishwasher, which operates in a normal manner. This whole maintenance operation takes Marvin less than three minutes. Marvin now pulls down a repair screen on his PDA for dishwashers in a step 116 to enter the proper repair code. Upon reviewing the thirty-three pre-defined dishwasher codes, Marvin fails to find one that is even relatively close to what the actual problem was, a lot less one that specifically describes the problem, which Marvin knows is a goal for proper use of the system 10.

Marvin thus is presented with two choices, entering a new code and description or just selecting the miscellaneous category preexisting code DW00 and entering the description of the problem. Marvin chooses the miscellaneous category preexisting code DW00 and enters the description of the problem in a step 118, since Marvin knows that this is a defect that is unlikely to reoccur. If the defect is one that is likely to reoccur, then Marvin or the office will enter a new code and description for the defect. Marvin then logs completion of the work order in a step 120 and returns the key to the office, if he has obtained one.

The completion by Marvin of the work order is logged into the database 14 and communicated to the supervisor, to notify the supervisor that the work order is completed and that Marvin now is free to accept another work order or to proceed with the next work order, after returning the key to the office. Marvin leave a pre-stamped post card with his name on it and Marvin writes on the card that he has fixed the dishwasher. Mrs. Bell then can send the card to the office with her comments or complaints or retain it for future reference. Also, since the system 10 is designed to be customer oriented, the server 12 can be prompted to or can automatically email Mrs. Bell to notify her that the dishwasher has been fixed in a step 124. Alternately and if email is not available, the office personnel will call Mrs. Bell to notify her. The email includes the office telephone number and asks Mrs. Bell to call or email if she has any questions.

Mrs. Bell however fails to check her email or telephone message and calls the office at the end of the day to inquire about the status of her dishwasher work order in a step 126. Nancy is already gone for the day and a new agent, Brenda, answers the phone. Brenda requests the unit number and that Mrs. Bell hold for a moment so that Brenda can check the database 14 to find the status of the work order. Brenda enters the unit number in the work order status and quickly finds that the work order has been logged as completed. Brenda then tells Mrs. Bell, who is pleased that the dishwasher is fixed.

This scenario emphasizes the various requirements for an efficient system 10. The system 10 must be user friendly at each level of input, work order entry, supervisor assignment, service technician action entry, notification of tenant, etc. In this case, the system 10 did not include a proper repair code for the problem, but since Marvin did not find a suitable code, he entered the miscellaneous code. This entry can be separately logged and tabulated, since it does not have a work order benchmark in the database. The code descriptions must be broad enough to cover a wide range of problems, but at the same time the codes should be detailed enough to properly identify the real problem. Also, the customer must be notified in as many ways as possible to insure satisfaction.

The database 14 also can include inventory tracking of parts for the work orders, warranty information and tracking, automatic purchase reordering following use of one or more parts during maintenance, customer billing, etc. The monitoring of the individual technicians and the work orders, allows technician performance rewards to be more objective and less subjective utilizing the system 10. This provides a way to improve productivity, skill levels and morale of the maintenance employees. The system 10 enables tracking of governmental directives, such as refrigerant control, monitoring and documentation. By maintaining the data on completed work orders in the database 14, the data can be analyzed to identify historical trends and to encourage preventive maintenance to improve and preserve asset value. Another key objective of the system 10 is to increase customer, tenant or resident satisfaction. This can be measured by reduced tenant turnover, reduced complaints by the tenants and an increase in receptivity to renewal rental increases. Tenants also should express an increased awareness of the attention, professionalism and ability of the office and maintenance staff to deliver faster and better response to the service requests. The system 10 also makes it easier for the tenants to make service requests and to obtain fast reliable information about the status of their requests.

The system 10 of the present invention can be utilized to provide numerous additional features, such as multiple location inventory tracking coordinated with the use of the inventory by the technicians as they complete the work orders. The inventory and use thereof can be monitored with respect to warranty information, automatic purchase orders where warranted by volume and type of part, including shelf life where applicable. The system 10 also facilitates customer billing when required.

A further reporting feature of the present invention also is provided by the system 10. The database 14 allows reports to be generated in any number of formats and allows for the work order status to be monitored by any person who has authorization to access the database information. In general such authorization is informational or active. The informational group may be authorized only to review the status of their personal work orders, such as residents or other customers and limited access office staff that may field inquires from the customers. The access can be provided by password or coded entry protection. The access may be limited to online reports on specific work orders or access can be provided to all or selected types of work orders and online or printed reports. The informational group also can include senior management with a need to know, who may require full informational access, but generally do not need to perform any actions other than monitoring of the data and generating of reports as will be discussed hereinafter in further detail. Those in the active group generally will be the on-site management staff, service supervisors and maintenance technicians. Again, their access will be password protected and will be various levels of access, as required.

In general, the management executives will require individual property reports and combined multi-property information, such as statistics and technician specific information. The supervisors will need online and printed reports, but also must have the ability to change or authorize changes in the system 10. The supervisors enter and monitor work orders, can edit, add work order detail and adjust time standards or benchmarks, as necessary. The on-site management staff generally will enter new work orders; monitor the work orders in process and access online and printed reports.

There are any numbers of online and customized reports, which can be generated utilizing the system 10. Examples of such reports follow and can include standard reports automatically generated or generated upon request by those users which are authorized to receive them and can include customized reports, again generated by those users authorized to do so. The reports can include date request specific reports, which include completed work orders by specific technicians and by type of work order. The reports can include an analysis of technician efficiency date specific if desired and specific to the type of work order, which can include the number of completed work orders, diagnosis of the problem, repair actions taken, actual elapsed time, the standard or benchmark time and the percent efficiency of the technician. The reports can be property specific and can be provided by work order type, source of the problem, completion status of the work orders, total elapsed completion times, technician and technician actions and the performance achievement of the technician for each type of work order, such as eighty-five (85%) percent of the benchmark for a plumbing type work order.

Some reports can or are mandated, such as a monthly EPA (Environmental Protection Agency) Refrigerant Report. This report is a monthly recap of all work orders, which resulted in refrigerant use. Typically, the report includes the work order number, the technician who performed the work order, start and stop times of the work order, refrigerant container identification number, problem diagnosis and problem solution. An overdue report is useful to identify those work orders, which are not completed within a predetermined time, such within twenty-four hours of receipt. The reports can include the work order number, the source of the problem, the time and date received, the technician assigned, the problem and diagnosis and estimated time of completion. A completed work order report is useful to provide an analysis of the operation of the system 10. The report can include the work order number, the assigned technician, the start, stop and elapsed time to complete the work order, the standard time or benchmark assigned to the work order, the problem diagnosis and the repair problem. This report can be used to identify the skill and training needs of the technician. This can be used to indicate additional training and to better assign the technicians to the various types of work orders. The technician's efficiency over an extended time frame can be monitored, such as before and after training on a particular type of work order.

A weekly overtime alert report can be generated weekly on a predetermined day of the week to be utilized by management to control overtime costs of the technicians. By requiring all overtime to be pre-approved, this report increases control, identifies problems and saves on overtime expenditures. The report can be generated for example on Thursday, in the morning or at noon, and will indicate the total time worked for each technician by Wednesday night and the projected total time for the week, assuming a full day on Thursday and Friday. A specific property recurring problem report can be generated to alert management when a predetermined number of a particular type of work order occurs. This can be utilized to identify poor preventive maintenance or failure of a specific part or type of equipment, such as supplied from a specific vendor. A similar chronic unit report can be generated, which identifies all the work order problems, which have occurred in specific units over a predetermined period of time, such as over the last three months. This report can be utilized to identify problem trends and to prevent similar problems in similar units. If a facility wide problem is identified, outsourcing of the repairs with collective bargaining may reduce costs and prevent future complaints from the customers/residents. In a similar manner, the reports can identify problem tenants.

A non-standard report can be generated to list all the non-standard work orders, which have been entered in a period of time. This can identify work orders, which are reoccurring and should have categories and benchmark times assigned to them. It also can identify a technician who has entered an unusual number of non-standard work orders, which can indicate a problem or the need for further training. The system 10 also can be utilized to educate the management team and the technicians about newly acquired properties. Previous data, where existing, can be entered and can be supplemented or replaced by data generated during one or more due diligence type inspections. This initial database then can be revised and updated by the new work orders generated on the property.

1. A method for processing maintenance work orders, comprising:
identifying a maintenance problem;
generating a work order for said maintenance problem in a computer, including at least the location of said problem and the type of said problem;
assigning said work order to a technician to fix said problem;
entering data from said technician in said computer relating to said technician completing said work order, including at least the action taken to fix said problem and the elapsed time to complete said work order; and
comparing said elapsed time entered by said technician for said completed work order to a predetermined standard benchmark for said type of maintenance problem to measure the efficiency of said technician in fixing said problem.

2. The method as defined in claim 1, including communicating said problem to a maintenance office.

3. The method as defined in claim 1, including electronically assigning said work order.

4. The method as defined in claim 1, including recording said technician work order assignment in said computer.

5. The method as defined in claim 1, including electronically transmitting and entering said data from said technician.

6. The method as defined in claim 1, including a customer identifying said maintenance problem.

7. The method as defined in claim 6, including said customer communicating said problem to a maintenance office.

8. The method as defined in claim 7, including said customer electronically communicating said problem to said maintenance office.

9. The method as defined in claim 6, including notifying said customer of the completion of said work order.

10. The method as defined in claim 6, including said customer electronically communicating said problem and generating said work order.

11. The method as defined in claim 10, including said customer electronically checking the status of the work order.

12. The method as defined in claim 1, including wirelessly transmitting said work order and electronically assigning said work order.

13. The method as defined in claim 1, including updating said standard benchmark with said elapsed time of said completed work order.

14. The method as defined in claim 1, including tailoring said work order to include specific characteristics of said location.

15. The method as defined in claim 1, including analyzing said elapsed time and said benchmark to determine if training of said technician is warranted.

16. The method as defined in claim 1, including analyzing said data and generating reports relating to said data and said technician.

17. The method as defined in claim 1, including analyzing said data and identify trends relating to said data.

18. A method for processing maintenance work orders, comprising:
identifying a maintenance problem;
communicating said problem to a maintenance office;
generating a work order for said maintenance problem in a computer, including at least the location of said problem and the type of said problem;
electronically assigning said work order to a technician to fix said problem;
recording said technician work order assignment in said computer;
electronically transmitting and entering data from said technician in said computer relating to said technician completing said work order, including at least the action taken to fix said problem and the elapsed time to complete said work order; and
comparing said elapsed time entered by said technician for said completed work order to a predetermined standard benchmark for said type of maintenance problem to measure the efficiency of said technician in fixing said problem.

19. The method as defined in claim 18, including a customer identifying said maintenance problem.

20. The method as defined in claim 19, including said customer communicating said problem to said maintenance office.

21. The method as defined in claim 20, including said customer electronically communicating said problem to said maintenance office.

22. The method as defined in claim 19, including notifying said customer of the completion of said work order.

23. The method as defined in claim 19, including said customer electronically communicating said problem and generating said work order.

24. The method as defined in claim 21, including said customer electronically checking the status of the work order.

25. The method as defined in claim 18, including wirelessly transmitting said work order and electronically assigning said work order.

26. The method as defined in claim 18, including updating said standard benchmark with said elapsed time of said completed work order.

27. The method as defined in claim 18, including tailoring said work order to include specific characteristics of said location.

28. The method as defined in claim 18, including analyzing said elapsed time and said benchmark to determine if training of said technician is warranted.

29. The method as defined in claim 18, including analyzing said data and generating reports relating to said data and said technician.

30. The method as defined in claim 18, including analyzing said data and identify trends relating to said data.

31. A method for processing maintenance work orders, comprising:
a customer identifying a maintenance problem;
said customer communicating said problem to a maintenance office;
generating a work order for said maintenance problem in a computer, including at least the location of said problem and the type of said problem;
wirelessly transmitting said work order and electronically assigning said work order to a technician to fix said problem;
recording said technician work order assignment in said computer;
electronically transmitting and entering data from said technician in said computer relating to said technician completing said work order, including at least the action taken to fix said problem and the elapsed time to complete said work order;
notifying said customer of the completion of said work order; and
comparing said elapsed time entered by said technician for said completed work order to a predetermined standard benchmark for said type of maintenance problem to measure the efficiency of said technician in fixing said problem.

32. The method as defined in claim 31, including said customer electronically communicating said problem to said maintenance office.

33. The method as defined in claim 31, including said customer electronically communicating said problem and generating said work order.

34. The method as defined in claim 32, including said customer electronically checking the status of the work order.

35. The method as defined in claim 31, including updating said standard benchmark with said elapsed time of said completed work order.

36. The method as defined in claim 31, including tailoring said work order to include specific characteristics of said location.

37. The method as defined in claim 31, including analyzing said elapsed time and said benchmark to determine if training of said technician is warranted.

38. The method as defined in claim 31, including analyzing said data and generating reports relating to said data and said technician.

39. The method as defined in claim 31, including analyzing said data and identify trends relating to said data.
